(19) United States
(12) Patent Application Publication
(10) Pub. No.: US 2002/0166806 A1
(43) Pub. Date: Nov. 14, 2002

(54) Waste water treatment system with an ion-selective membrane

(75) Inventor: Joseph Kuo, Taichung City (TW)

Correspondence Address: KRAMER, LEVIN, NAFTALIS & FRANKEL LLP, 919 Third Avenue, New York, NY, 10022-3852, US

(73) Assignee: KINTECH TECHNOLOGY CO., LTD

(21) Appl. No.: 09/850,698

(22) Filed: May 8, 2001

(51) Int. Cl. B01D 61/00; B01D 61/46

(52) U.S. Cl. 210/252; 210/294; 210/321.6; 204/627

(57) ABSTRACT

A waste water treatment system includes an electrodialysis reactor, a negative electrode plate immersed in waste water in the reactor, an anion-selective membrane unit defining a compartment and immersed in the waste water in the reactor for selectively permitting negative ions in the waste water to enter into an interior of the compartment, and a reverse osmosis membrane unit for periodically receiving the waste water from the reactor to separate the waste water into a stream of concentrated solution and a stream of water.

### BACKGROUND OF THE INVENTION

1. Field of the Invention

This invention relates to a waste water treatment system, more particularly to a waste water treatment system with an ion-selective membrane unit.

2. Description of the Related Art

It is well known that waste water from electroplating and metal treatment industries contains large amounts of metal ions, and has a strong acidity or basicity. Such waste water, when treated with chemicals by chemical treatment, results in tremendous amounts of non-recoverable and nonrecyclable sludge.

A recovering method has been proposed heretofore for recovering the metal ions in the waste water by employing a reverse osmosis apparatus which separates the waste water into a water stream and a concentrated solution. The metal ions in the concentrated solution are then recovered by electroplating techniques. However, the known recovering method is disadvantageous in that the reverse osmosis apparatus is susceptible to the strong acidity of the concentrated solution and to the metal ions such that the apparatus tends to be corroded and to be blocked.

### SUMMARY OF THE INVENTION

Therefore, it is an object of the present invention to provide a waste water treatment system with an ion-selective membrane unit that is capable of overcoming the aforementioned drawbacks.

According to the present invention, there is provided a waste water treatment system for treating waste water which contains complementary metal ions and negative ions. The waste water treatment system comprises: a waste water container adapted to receive the waste water therein; an electrodialysis reactor adapted to receive periodically the waste water from the waste water container; a negative electrode plate adapted to be immersed in the waste water in the reactor and adapted to be electrically connected to a first wire of a power supply for attracting the metal ions in the waste water; an anion-selective membrane unit adapted to be immersed in the waste water in the reactor, and adapted to be electrically connected to a second wire of the power supply, the membrane unit defining therein first and second compartments that are in fluid communication with each other, and having an inlet in fluid communication with the second compartment and an outlet in fluid communication with the first compartment, the first compartment being defined by an anion-selective membrane member that is adapted to selectively permit the negative ions in the waste water to enter into an interior of the first compartment; a negative ion-concentrated container adapted to receive a solvent which is circulated to pass through the first and second compartments for extracting the negative ions from the interior of the first compartment; and a reverse osmosis membrane unit adapted to periodically receive the waste water from the reactor and to separate the waste water into a stream of concentrated solution that is recycled to the waste water container, and a stream of water.

### BRIEF DESCRIPTION OF THE DRAWINGS

In drawings which illustrate an embodiment of the invention,

FIG. 1 is a perspective view to illustrate an electrodialysis reactor of a waste water treatment system embodying this invention;

FIG. 2 is a perspective view to illustrate a reverse osmosis membrane unit of the waste water treatment system of FIG. 1;

FIG. 3 is a schematic block diagram to illustrate the waste water treatment system of FIG. 1;

FIG. 4 is a cross-sectional side view to illustrate an anion-selective membrane unit of the waste water treatment system of FIG. 1; and

FIG. 5 is a cross-sectional side view to illustrate a negative electrode plate surrounded by a cation-selective membrane of the waste water treatment system of FIG. 1.

### DETAILED DESCRIPTION OF THE PREFERRED EMBODIMENT

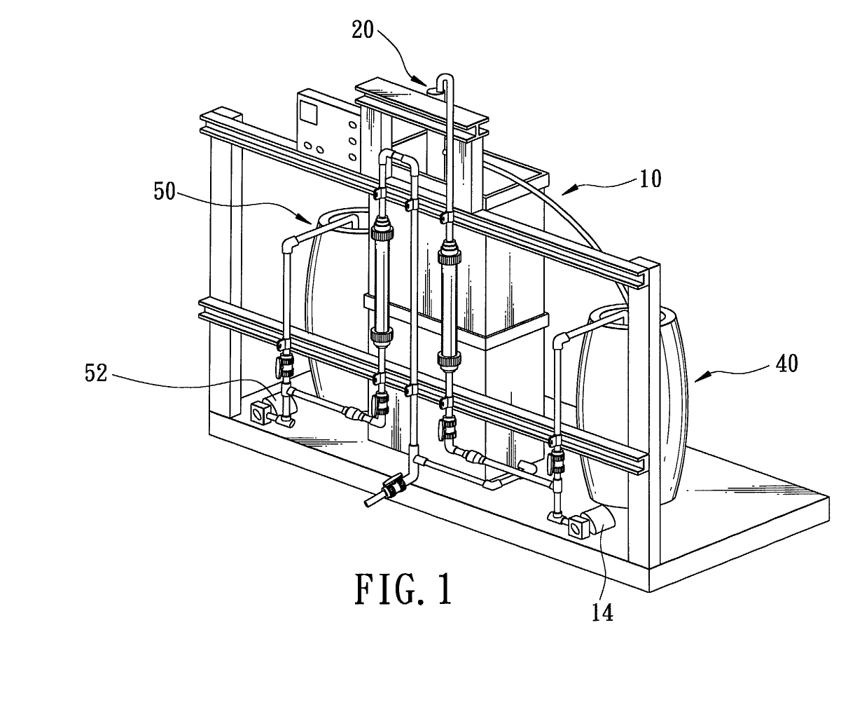

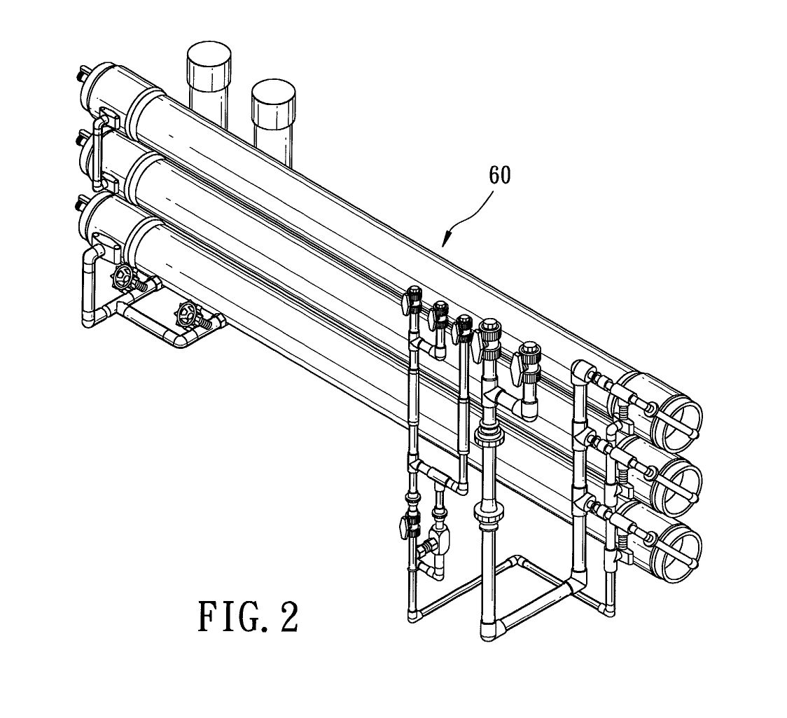

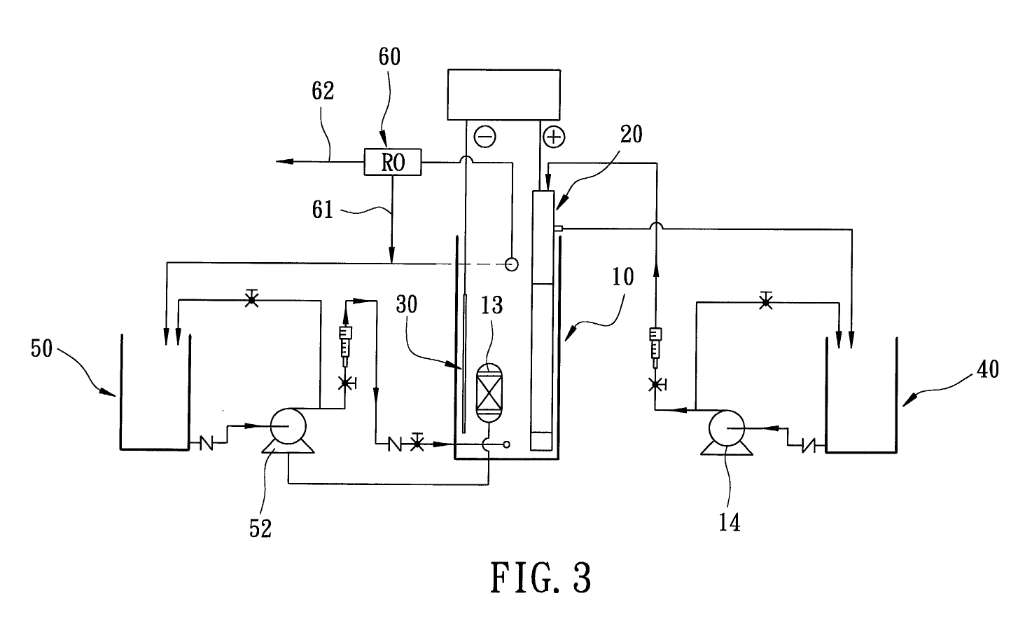

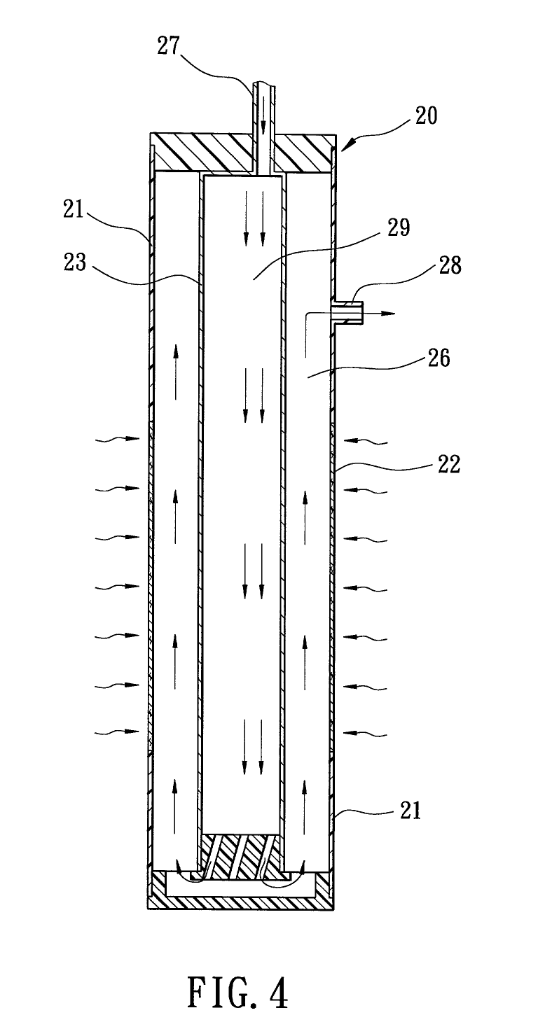

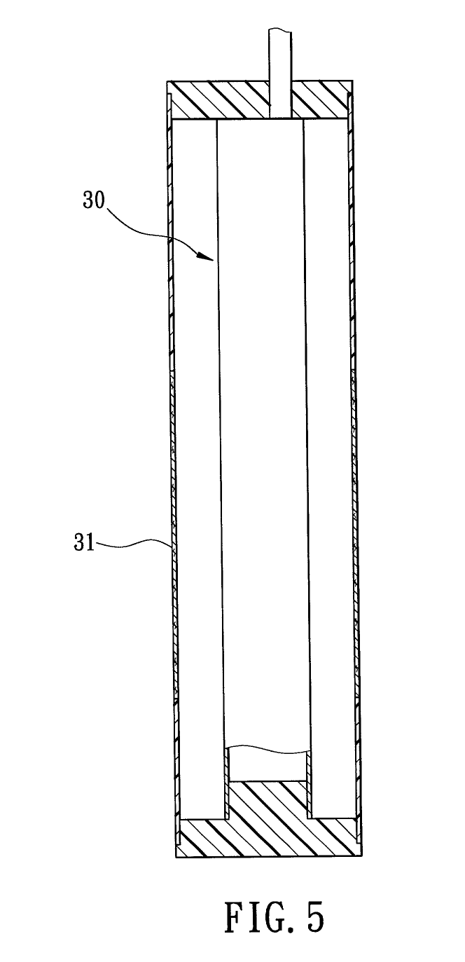

FIGS. 1 to 5 illustrate a preferred embodiment of a waste water treatment system of this invention for treating waste water, such as waste water from electroplating and metal treating industries, which contains complementary metal ions and negative ions therein. The waste water treatment system includes: a waste water container 50 adapted to receive the waste water therein; an electrodialysis reactor 10 adapted to receive periodically the waste water from the waste water container 50 via a feeding pump 52; a negative electrode plate 30 adapted to be immersed in the waste water in the reactor 10 and adapted to be electrically connected to a first wire (not shown) of a power supply for attracting the metal ions in the waste water; an anion-selective membrane unit 20 adapted to be immerses in the waste water in the reactor 10, and adapted to be electrically connected to a second wire of the power supply, the membrane unit 20 defining therein first and second compartments 26, 29 that are in fluid communication with each other, and having an inlet 27 in fluid communication with the second compartment 29 and an outlet 28 in fluid communication with the first compartment 26, the first compartment 26 being defined by a tubular anion-selective membrane member that includes upper and lower conductive tubes 21 and a membrane tube 22 which interconnects the upper and lower conductive tubes 21 and which is adapted to selectively permit the negative ions in the waste water to enter into an interior of the first compartment 26, the second compartment 29 being defined by a conductive tube 23 which is surrounded by the anion-selective membrane member 22; a negative ion-concentrated container 40 adapted to receive a solvent, such as water, which is circulated to pass through the first and second compartments 26, 29 by a circulating pump 14 for extracting the negative ions from the interior of the first compartment 22; and a reverse osmosis membrane unit 60 adapted to periodically receive the waste water from the reactor 10 and to separate the waste water into a concentrated solution stream 62 that is recycled to the waste water container 50, and a water stream 62. A regulating device includes a concentration sensor 13 for detecting the concentration of the metal and negative ions in the reactor 10. The regulating device actuates the feeding pump 52 to regulate the concentration of the metal and negative ions in the waste water in the reactor 10 in order to ensure efficient removal of the metal and negative ions in the waste water during the course of the electrodialysis.

Preferably, the waste water treatment system further includes a cation-selective membrane member 31 that is spaced apart from and that surrounds the negative electrode plate 30, and that is adapted to selectively permit the metal ions from the waste water in the reactor 60 to pass therethrough, and that is adapted to prevent undesired materials, such as organic materials, from moving close to the negative electrode plate 30.

With the negative electrode plate 30 and the anion-selective membrane unit 20 in the reactor 10, the drawbacks as encountered in the prior art can be eliminated.

With the invention thus explained, it is apparent that various modifications and variations can be made without departing from the spirit of the present invention.

I claim:

1. A waste water treatment system for treating waste water, which contains complementary metal ions and negative ions, such system comprising:
a waste water container adapted to receive the waste water therein;
an electrodialysis reactor adapted to receive periodically the waste water from the waste water container;
a negative electrode plate adapted to be immersed in the waste water in the reactor and adapted to be electrically connected to a first wire of a power supply for attracting the metal ions in the waste water;
an anion-selective membrane unit adapted to be immersed in the waste water in the reactor, and adapted to be electrically connected to a second wire of the power supply, the membrane unit defining therein first and second compartments that are in fluid communication with each other, and having an inlet in fluid communication with the second compartment and an outlet in fluid communication with the first compartment, the first compartment being defined by an anion-selective membrane member that is adapted to selectively permit the negative ions in the waste water to enter into an interior of the first compartment;
a negative ion-concentrated container adapted to receive a solvent which is circulated to pass through the first and second compartments for extracting the negative ions from the interior of the first compartment; and
a reverse osmosis membrane unit adapted to periodically receive the waste water from the reactor and to separate the waste water into a stream of concentrated solution that is recycled to the waste water container, and a stream of water.

2. The waste water treatment system of claim 1, further comprising a regulating device for regulating the concentration of the metal and negative ions in the waste water in the reactor to ensure efficient removal of the metal and negative ions.

3. The waste water treatment system of claim 1, further comprising a cation-selective membrane that is spaced apart from and that surrounds the negative electrode plate, and that is adapted to selectively permit the metal ions from the waste water to pass therethrough.
